(19) United States
(12) Patent Application Publication
(10) Pub. No.: US 2013/0036032 A1
(43) Pub. Date: Feb. 7, 2013

(54) SERVICE PLAN NEGOTIATIONS WITH END USERS FOR POLICY AND CHARGING CONTROL (PCC)

(71) Applicants: Yigang Cai, Naperville, IL (US); Suzann Hua, Lisle, IL (US)

(72) Inventors: Yigang Cai, Naperville, IL (US); Suzann Hua, Lisle, IL (US)

(21) Appl. No.: 13/198,573

(22) Filed: Aug. 4, 2011

(51) Int. Cl. G06Q 99/00; G06Q 30/00

(52) U.S. Cl. 705/30; 705/1.1

(57) ABSTRACT

Systems and methods are disclosed for negotiating service plans with an end user for Policy and Charging Control (PCC) in a packet core network, such as an LTE network. A system in one embodiment communicates with an end user that has a predefined service plan. The predefined service plan is used for a PCC decision when the end user requests a service. The system receives a request from the end user offering a proposed service plan that differs from the predefined service plan, and processes the proposed service plan to determine whether to accept the offer from the end user. If the determination is to accept the offer, then the system implements the proposed service plan for the end user in a PCC decision for a service requested by the end user instead of the predetermined service plan.

### FIELD OF THE INVENTION

The invention is related to the field of communication systems and, in particular, to systems and methods that allow for end users to negotiate service plans for Policy and Charging Control (PCC).

### BACKGROUND

Service providers typically provide numerous voice and data services to end users (also referred to as subscribers). Examples of voice services are voice calls, call forwarding, call waiting, etc. Examples of data services are streaming audio, streaming video, Voice over Internet Protocol (VoIP), online gaming, and IP-TV. The data services are managed by a packet core network, which interfaces the end user with external packet data networks (PDN), such as the internet. Some examples of packet core networks are a General Packet Radio Service (GPRS) core network, an Evolved Packet Core (EPC) network, etc. To utilize data services, an end user uses a mobile device, such as a cell phone, a personal data assistant, a smart phone, etc, to connect with a Radio Access Network (RAN). The RAN may be a packet-based network that provides IP connectivity, which is also referred to as an IP Connectivity Access Network (CAN). The RAN in turn connects to the packet core network in order to provide the end user with access to the data services.

When the mobile device initiates a data session (e.g., an IP-CAN session), the session request from the mobile device includes a description of the requested data service (e.g., online gaming, IP-TV, etc). The packet core network authenticates the mobile device and determines which data services the mobile device is authorized to receive. If the requested service is authorized, then the packet core network reserves a bearer path (e.g., an IP CAN bearer) of a defined capacity, delay, and bit error rate over a selected Packet Data Network (PDN). A flow of packets may then begin for the service, which is referred to as a service data flow over the PDN.

The network operators implement Policy and Charging Control (PCC) within their networks to control how services are provided to the end users. Policy control refers to the process of controlling the bearer path for service data flows, such as for bearer establishment, Quality of Service (QoS) control, and gating control (blocking or allowing packets to pass). Policy rules are predefined for each end user that govern which network services the end user is allowed to access, the bandwidth level that is provided, when the services are allowed, how long the services are allowed, etc. Charging control refers to the process of associating packets of a service data flow to a charging key or identifier, and applying online charging and/or offline charging as appropriate. Charging rules are predefined for each end user that govern the type of charging applied to a service, the tariff(s) applied to a service, etc. The policy rules and charging rules are set out in a service plan subscribed to by the end user.

The 3rd Generation Partnership Project (3GPP, 3GPP2) has defined a PCC architecture for packet core networks. One example of a PCC architecture is described in 3GPP TS 23.203 (Release 9). The PCC architecture suggested by the 3GPP includes a Policy and Charging Rules Function (PCRF), a PDN gateway comprising a Policy and Charging Enforcement Function (PCEF), an application function (AF), a Bearer Binding and Event Reporting Function (BBERF), a Home Subscriber Server (HSS)/Subscription Profile Repository (SPR), an Online Charging System (OCS), and an Offline Charging System (OFCS). As a brief description of some of the elements of the PCC architecture, the PCRF makes policy control decisions and flow-based charging control decisions to select which PCC rules to implement for a service data flow. The PCEF in the gateway provides service data flow detection, user plane traffic handling, QoS handling, service data flow measurement, and online/offline charging interactions. The HSS/SPR stores subscriber data and subscription related information for end users, such as in subscriber profiles.

The PCRF in the PCC architecture makes a PCC decision when an end user requests a service. Presently, the PCRF makes the PCC decision based on a predefined set of policy rules and charging rules for the end user that are set out in his/her service plan. This unfortunately does not allow for much flexibility in selecting the PCC rules to apply to a requested service.

### SUMMARY

Embodiments described herein allow an end user to negotiate different service plans in real-time with the PCRF. Although there is a predefined service plan existing for the end user, the PCRF allows the end user to offer a proposed service plan that is different than the predefined service plan. The PCRF then processes the offer from the end user along with other information, such as the predefined service plan, network traffic data, etc., to determine whether or not to accept the offer from the end user. If the offer is accepted, then the proposed service plan will be used by the PCRF in the PCC decision for the end user (at least temporarily). If the offer is not accepted, then the PCRF may deny the proposed service plan and make the PCC decision based on the predefined service plan, or send a counter-offer to the end user. The PCRF and end user may continue to exchange counter-offers until an agreement on a proposed service plan is reached. The negotiation benefits the end user by allowing the end user to temporarily receive a more favorable service plan, such as a more favorable rate, bandwidth, QoS, etc. The negotiation also benefits the network operator by encouraging the end user to utilize services and network resources that may not be otherwise utilized under the predefined service plan. For example, the end user may be more likely to access an IP-TV service if he/she receives a more favorable rate and bandwidth for a time period.

One embodiment comprises a system that negotiates service plans with an end user in real-time. The system includes a policy management interface operable to communicate with an end user that has a predefined service plan. The predefined service plan may be used for a PCC decision in a packet core network when the end user requests a service. The policy management interface is further operable to receive a request from the end user offering a proposed service plan that differs from the predefined service plan. The system further includes a policy management controller operable to process the proposed service plan to determine whether to accept the offer from the end user. If the determination is to accept the offer, then the policy management controller is further operable to implement the proposed service plan for the end user in a PCC decision for a service requested by the end user. If the determination is to reject the offer, then the policy management controller is further operable to implement the predefined service plan for the end user in a PCC decision for a service requested by the end user.

In another embodiment, if the determination is to reject the offer from the end user, then the policy management controller is further operable to generate an alternate service plan as a counter-offer to the end user, and to transmit a response to the end user counter-offering with the alternate service plan that differs from the proposed service plan.

In another embodiment, the policy management controller is further operable to receive an answer from the end user to the counter-offer. If the end user accepted the counter-offer, then the policy management controller is further operable to implement the alternate service plan for the end user in a PCC decision for a service requested by the end user.

In another embodiment, if the end user rejected the counter-offer, then the policy management controller is further operable to generate another alternate service plan as another counter-offer to the end user, and to continue to negotiate with the end user.

Other exemplary embodiments may be described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 illustrates a PCC architecture for a packet core network in an exemplary embodiment.

FIG. 2 illustrates a PCRF in an exemplary embodiment.

FIG. 3 is a flow chart illustrating a method of negotiating for a proposed service plan in an exemplary embodiment.

FIG. 4 is a flow chart illustrating another method of negotiating for a proposed service plan in an exemplary embodiment.

FIG. 5 illustrates a Long Term Evolution/Evolved Packet Core (LTE/EPC) network in an exemplary embodiment.

FIG. 6 is a message diagram illustrating an example of negotiating for a new service plan in an exemplary embodiment.

### DESCRIPTION OF EMBODIMENTS

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

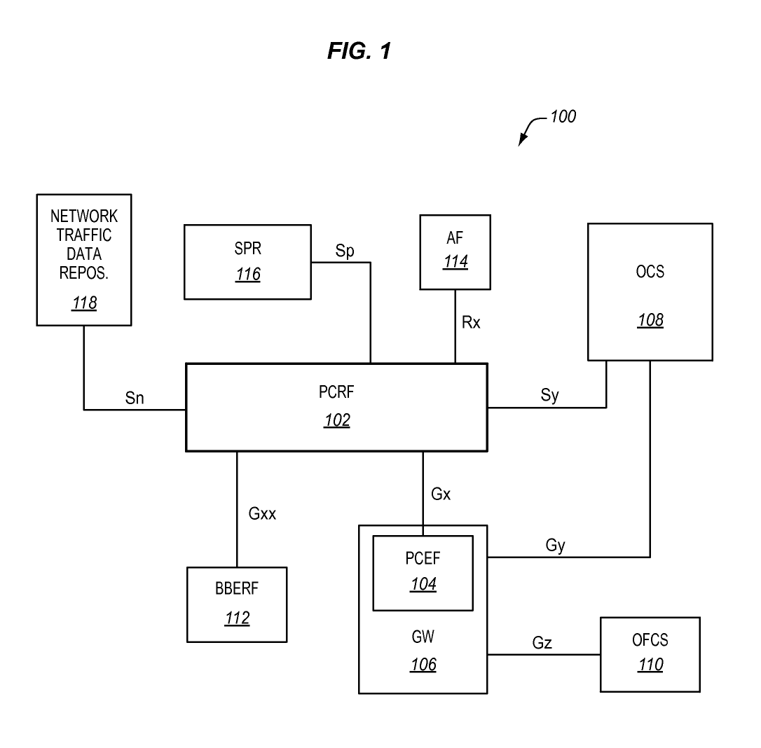

FIG. 1 illustrates a Policy and Charging Control (PCC) architecture 100 for a packet core network in an exemplary embodiment. The PCC architecture 100 may be used in a Long Term Evolution/Evolved Packet Core (LTE/EPC) network or another type of 4G network. PCC architecture 100 includes a Policy and Charging Rules Function (PCRF) 102 and a Policy and Charging Enforcement Function (PCEF) 104 that together provide a Policy and Charging Control (PCC) solution in the packet core network. PCRF 102 is a node of the network that generates PCC rules for a requested service, which is referred to as making a PCC decision. PCRF 102 may include a policy engine (not shown) that makes the PCC decision. Although the term “PCRF” is used in this description, the functionality of PCRF 102 is applicable to any network node that makes policy decisions in a packet core network.

PCEF 104 is a node that enforces the PCC rules for the requested service. For example, PCEF 104 may set up bearer connections for the service, modify existing bearer connections, ensure that only authorized service data flows are established, ensure that QoS limits are not exceeded, etc. PCEF 104 is typically implemented in a gateway (GW) 106, such as packet data gateway (P-GW) in an EPC network.

PCC architecture 100 further includes an Online Charging System (OCS) 108, an Offline Charging System (OFCS) 110, a Bearer Binding and Event Reporting Function (BBERF) 112, an application function (AF) 114, a Subscriber Profile Repository (SPR) 116, and a Network Traffic Data Repository (NTDR) 118. OCS 108 provides online charging for services/sessions accessed by end users. In addition, OCS 108 stores charging rules/plans for the end users which PCRF 102 may use when making a PCC decision. For example, charging rules may define that an end user is a prepaid subscriber, and may define tariffs for different services requested by the end user. PCRF 102 interfaces with OCS 108 via a Diameter Sy interface or any other protocol to exchange charging rules/plans with OCS 108. Although not shown in FIG. 1, OCS 108 may include an Online Charging Function (OCF), an Account Balance Management Function (ABMF), and a Rating Function (RF). The ABMF has a subscriber account database that stores account data, and the RF has a tariff database that stores tariffs for the end users.

OFCS 110 provides offline charging for services/sessions accessed by end users. OFCS 110 does not have an active, real-time role in the PCC, so it will not be discussed further.

Application Function (AF) 114 is a node in the packet data network (e.g., Internet, IMS, etc) that provides services requested by an end user. AF 114 describes a requested service to PCRF 102 via a Diameter Rx interface or other suitable protocol interface. For example, AF 114 may provide IP-addresses, port numbers, bit rates, delay sensitivity, etc, for requested services to PCRF 102. PCRF 102 may then use this information when making the PCC decision.

SPR 116 stores subscriber profiles for end users. The subscriber profiles may include policy rules (and possibly charging rules) that are used by PCRF 102 to make a PCC decision. The policy rules govern which network services the end user is allowed to access, the bandwidth level that is provided, the time(s) when the services are allowed, the duration of how long the services are allowed, etc. SPR 116 interfaces with PCRF 102 via a Diameter Sp interface or any other protocol used to exchange policy rules with PCRF 102.

The policy rules and charging rules together are referred to herein as a service plan (or PCC plan). Typically, a service plan is predefined for each end user.

NTDR 118 stores traffic data for the packet core network. The traffic data may vary with time, location, service flows, service directions, etc. NTDR 118 interfaces with PCRF 102 via a Diameter Sn interface or any other suitable protocol interface to send the traffic data (real-time or history) for PCC decisions.

In the embodiments described below, PCRF 102 is enhanced to allow an end user to negotiate the service plan that is used for services requested by the end user. For example, if an end user has a predefined service plan, then PCRF 102 allows the end user to negotiate for different service rules for a particular service, for a time period, etc. Consider the case where an end user has a predefined service plan governing data services, such as:

1024 kbps Downlink (DL)/128 kbps Uplink (UL) with $0.50 per Gb;

2048 kbps DL/512 kbps UL with $1.50 per Gb.

PCRF 102 may allow the end user to negotiate a different service plan, such as:

1024 kbps DL/128 kbps UL with $0.10 per Gb;

2048 kbps DL/512 kbps UL with $0.50 per Gb.

PCRF 102 and the end user may exchange offers and counter-offers until they agree on a new service plan. If an agreement is reached, then the new service plan is used in a PCC decision for services requested by the end user. The new service plan may be conditional and/or for a temporary duration. For example, the new service plan may be used for one or more of a given time window, location, service type, tariff type, volume, bandwidth, etc.

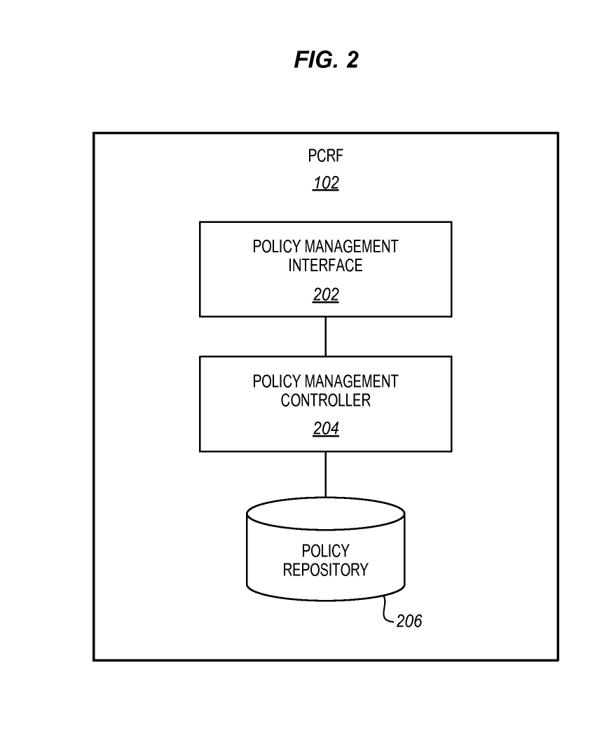

FIG. 2 illustrates PCRF 102 in an exemplary embodiment. In this embodiment, PCRF 102 includes a policy management interface 202, a policy management controller 204, and a policy repository 206. Policy management interface 202 provides end users access to PCRF 102 to negotiate the service plans. For example, policy management interface 202 may allow an end user (through his/her end user device or User Equipment (UE)) to exchange communications with PCRF 102 through AF 114 (see also FIG. 1). Policy management controller 204 is part of the function that makes PCC decisions, which includes the policy engine. Policy management controller 204 also handles the negotiations with the end user over service plans to determine whether to accept an offer from the end user, whether to provide a counter-offer to the end user, whether to deny an offer from the end user, etc. Policy repository 206 stores PCC rules for end users.

Before an end user negotiates a new service plan, one assumption is that a service plan already exists for the end user. The existing service plan may be predefined in a subscriber profile for the end user, such as the profile stored in SPR 116 (see FIG. 1), as well as in OCS 104 (charging rules). The end user may then negotiate for a new service plan to be implemented on a temporary basis in PCC architecture 100.

Through an appropriate User Equipment (UE), the end user may input data into an interface that represents an offer from the end user for a proposed service plan to use for one or more services requested by the end user. For example, the end user may input the following into an interface on the UE:

1024 kbps DL/128 kbps UL with $0.10 per Gb;

2048 kbps DL/512 kbps UL with $0.50 per Gb.

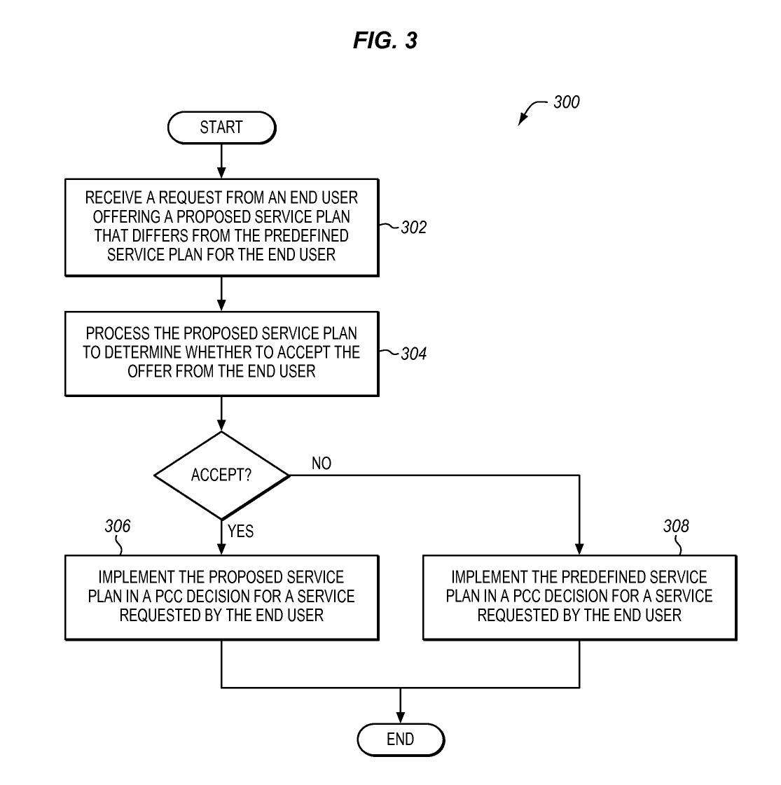

This input represents a new service plan (or a portion or subset of a new service plan) proposed by the end user to PCC architecture 100. The UE then sends a request toward PCC architecture 100 in FIG. 1 that includes the offer from the end user. For instance, the UE may send the offer to AF 114, and AF 114 may forward the offer to PCRF 102. PCRF 102 then operates as described in FIG. 3 to negotiate with the end user for a temporary service plan.

FIG. 3 is a flow chart illustrating a method 300 of negotiating for a temporary service plan in an exemplary embodiment. The steps of method 300 are described with reference to PCC architecture 100 in FIG. 1 and PCRF 102 in FIG. 2, although methods described herein may be performed in other nodes or systems. The steps of the flow charts described herein are not all inclusive and may include other steps not shown. The steps may also be performed in an alternative order.

In step 302, policy management interface 202 (see FIG. 2) receives a request from the end user offering a proposed service plan. When the term “end user” is used herein, the term may apply to an individual user and/or the combination of an individual user and a device (e.g., UE). The proposed service plan from the end user differs from the predefined or existing service plan for the end user. For instance, the proposed service plan may offer a different tariff than the predefined service plan. The proposed service plan may offer a different bandwidth than the predefined service plan. The proposed service plan offered by the end user may not be a complete plan, but is more likely data related to a portion or subset of a service plan.

In step 304, policy management controller 204 processes the proposed service plan (and possibly other information such as the predefined service plan) to determine whether to accept the offer from the end user. Policy management controller 204 determines whether the proposed service plan conforms to the policy rules and/or charging rules that are applicable to the end user. Some of the policy rules and charging rules are specific to the subscriber and are defined in the predefined service plan for the end user. Additionally, there may be global policy rules and charging rules that apply to the end user. For instance, the global policy rules and charging rules may be based on the class of service for the end user's subscription, location of the end user, etc. Thus, there may be multiple rules that are applicable to any given end user.

The predefined service plan may be stored in policy repository 206 of PCRF 102. If not, policy management controller 204 may retrieve the predefined service plan from SPR 116 and/or OCS 108. For instance, policy management controller 204 may retrieve a subscriber profile for the end user from SPR 116 (e.g., over the Diameter Sp interface). The subscriber profile includes the policy rules for the service plan of the end user. Policy management controller 204 may also retrieve charging rules for the end user from OCS 108 (e.g., over a Diameter Sy interface). The charging rules are also part of the service plan of the end user.

Policy management controller 204 may process any additional information to determine whether to accept the offer from the end user. For example, policy management controller 204 may retrieve network traffic data from NTDR 118 (e.g., over the Diameter Sn interface). Network traffic data comprises any information on bearer communications in the packet core network, such as busy hour transactions rate (and semi-busy hour, off peak time), service usages per busy hour, bandwidth availability, registered subscribers, average QoS usages, etc. Policy management controller 204 processes the network traffic data along with the proposed service plan and the predefined service plan to determine whether to accept the offer from the end user.

If the determination is to accept the offer from the end user, then policy management controller 204 implements the proposed service plan for the end user in step 306. The proposed service plan will then be used by PCRF 102 in a PCC decision for a service requested by the end user. As part of implementing the proposed service plan, policy management controller 204 may store the proposed service plan in policy repository 206 with an indication that the proposed service plan is the selected or active plan.

The proposed service plan is temporary and there may be conditions attached to the plan, such as a time limit, service limit, location limit, etc. For example, the proposed service plan may be used in PCC decisions for a duration of time, such as 24 hours. The proposed service plan may be used in PCC decisions while the end user is at a particular location. The proposed service plan may be used in PCC decisions for particular service/media types. The negotiation for the new service plan is not intended to result in a permanent change to the service plan of the end user, but instead as a temporary change to the service plan.

If the determination is to reject the offer from the end user, then policy management controller 204 may implement the predetermined service plan for the end user in step 308. The predefined service plan will then be used by PCRF 102 in a PCC decision for a service requested by the end user. As part of implementing the predefined service plan, policy management controller 204 may store the predefined service plan in policy repository 206 with an indication that the predefined service plan is the selected or active plan.

If the end user requests a service from the packet-core network, then PCEF 104 (see FIG. 1) receives the request, and in turn sends a request to PCRF 102 for a PCC decision. PCRF 102 retrieves the service plan for the end user that includes the policy rules and/or the charging rules for the end user. If the proposed service plan is implemented, then PCRF 102 makes the PCC decision based on the proposed service plan to generate PCC rules for the service. If the predefined service plan is implemented, then PCRF 102 makes the PCC decision based on the predefined service plan to generate the PCC rules for the service. PCEF 104 then enforces the PCC rules when the service is provided to the end user.

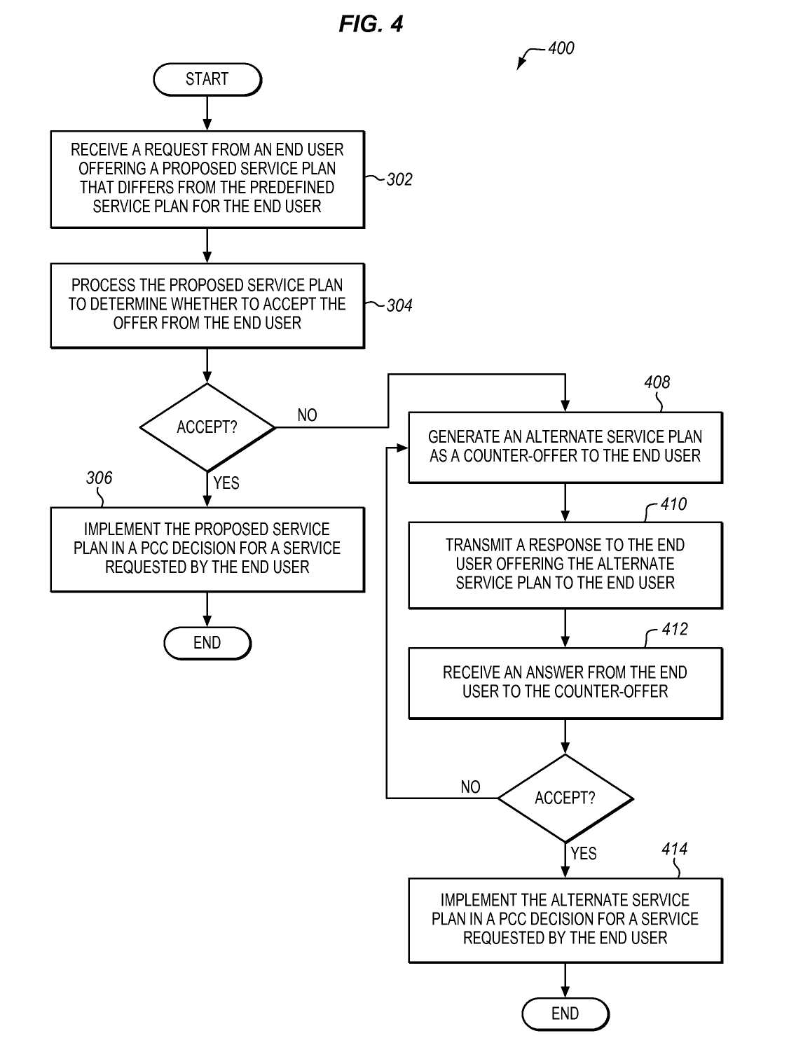

When policy management controller 204 rejects the initial offer from the end user, there may be further negotiation between the end user and policy management controller 204, which is further illustrated in FIG. 4. FIG. 4 is a flow chart illustrating another method 400 of negotiating for a proposed service plan in an exemplary embodiment.

Steps 302-306 in FIG. 4 are similar to the steps of FIG. 3. In FIG. 4, if the determination is to reject the offer from the end user, then policy management controller 204 generates one or more alternate service plans as a counter-offer to the end user in step 408. Policy management controller 204 takes into account the offer from the end user and the policy and/or charging rules in the predefined service plan when generating the counter-offer. The alternate service plan should therefore be a compromise between the proposed service plan and the predefined service plan, but still conforms with the (subscriber-specific and global) policy and/or charging rules. Policy management controller 204 then transmits a response to the end user counter-offering the alternate service plan(s) in step 410.

The end user may then view the alternate service plan(s) provided by PCRF 102. For example, assume that the initial offer from the end user is:

1024 kbps DL/128 kbps UL with $0.10 per Gb;

2048 kbps DL/512 kbps UL with $0.50 per Gb.

Policy management controller 204 may then counter-offer with an alternate service plan, such as:

(1) Day Time

1024 kbps DL/128 kbps UL with $0.20 per Gb;

2048 kbps DL/512 kbps UL with $0.75 per Gb.

(2) Evening

1024 kbps DL/128 kbps UL with $0.10 per Gb;

2048 kbps DL/512 kbps UL with $0.50 per Gb.

The end user can then decide whether or not to accept the counter-offer from PCRF 102, and respond accordingly.

In step 412, policy management controller 204 receives an answer from the end user to the counter-offer. If the end user accepts a counter-offer, then policy management controller 204 implements the alternate service plan for the end user in step 414. The alternate service plan will then be used by PCRF 102 in a PCC decision for a service requested by the end user. As part of implementing the alternate service plan, policy management controller 204 may store the alternate service plan in policy repository 206 with an indication that the alternate service plan is the selected or active plan. Policy management controller 204 may also store the proposed service plan and the predefined service plan in policy repository 206.

If the end user rejects the counter-offer from the end user, then policy management controller 204 may generate one or more alternate service plans as another counter-offer to the end user in step 408. Steps 410-412 then repeat as described above based on the new counter-offer. This process of negotiation between the end user and PCRF 102 continues until an agreement is reached or until PCRF 102 determines that no agreement will be reached. If an agreement is reached on a temporary service plan, then policy management controller 204 makes a PCC decision based on the temporary service plan. If no agreement is reached, then policy management controller 204 makes a PCC decision based on the predefined or existing service plan for the end user.

By allowing the end user to negotiate a better service plan in real-time, both the end user and the network operator may benefit. The end user benefits by temporarily receiving a more favorable service plan, such as a more favorable rate, bandwidth, QoS, etc. The network operator benefits by encouraging the end user to utilize services and network resources that may not be otherwise utilized under the predefined service plan. For example, the end user may be more likely to access an IP-TV service if he/she receives a more favorable rate and bandwidth for a time period.

### EXAMPLE

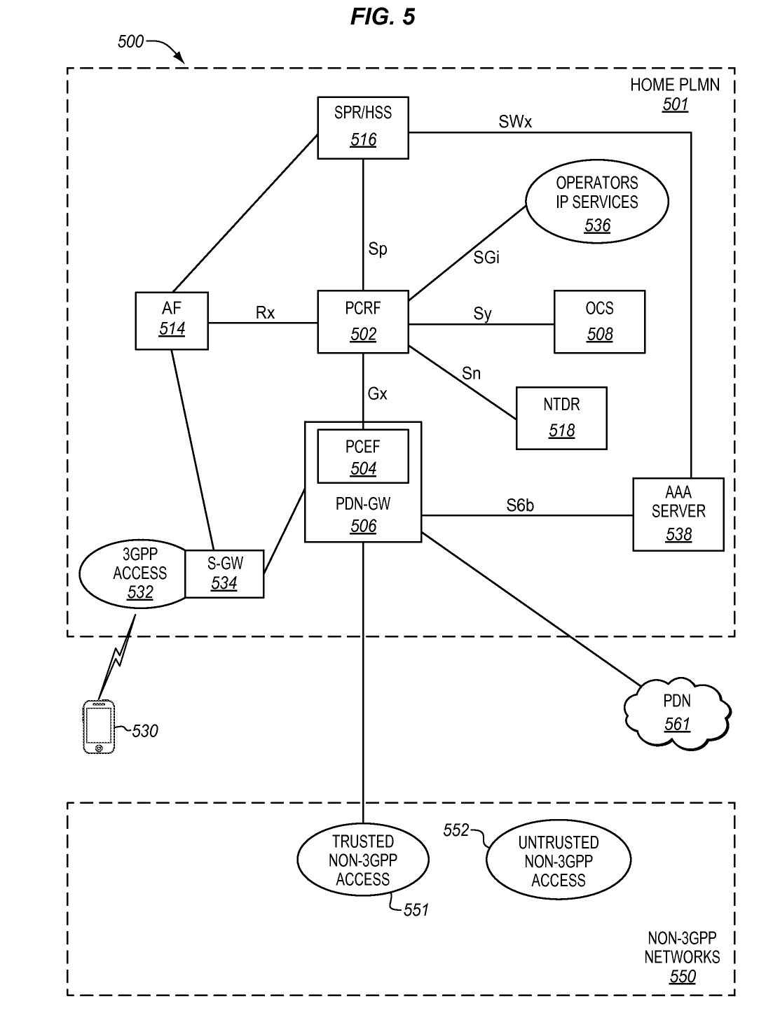

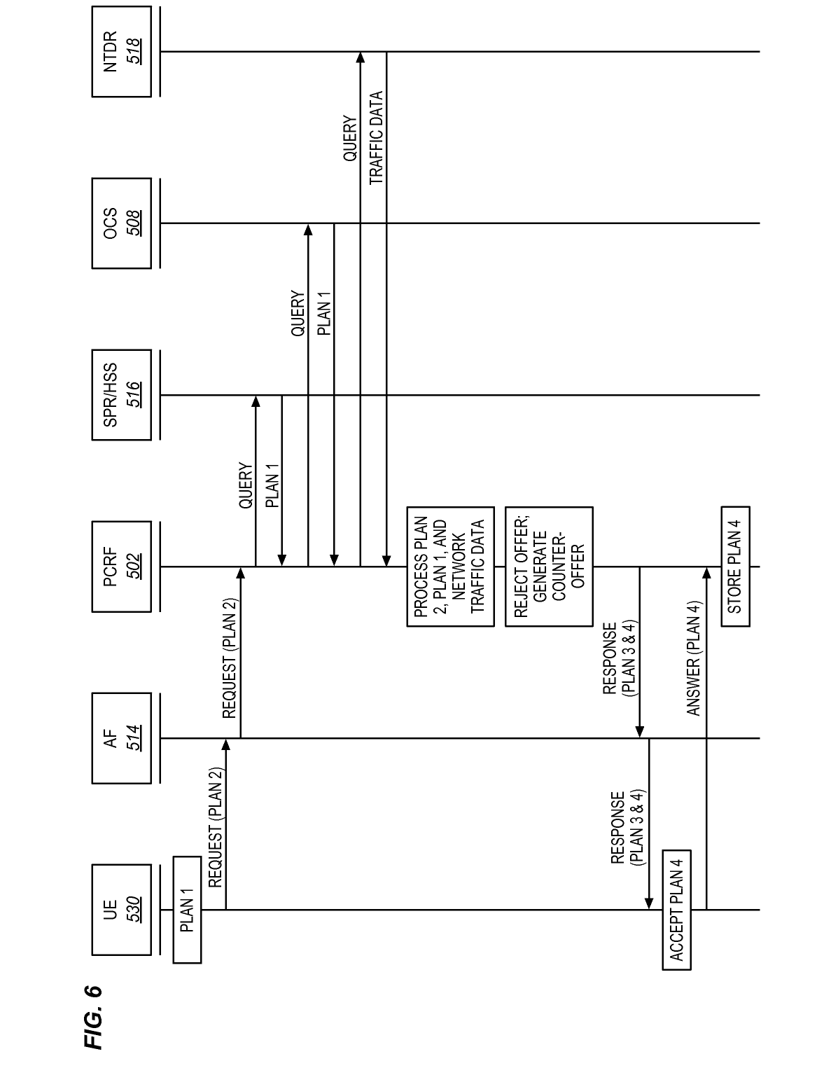

FIGS. 5-6 illustrate an example of negotiating service plans between a PCRF and an end user within a Long Term Evolution/Evolved Packet Core (LTE/EPC) network. FIG. 5 illustrates an LTE/EPC network 500 in an exemplary embodiment. LTE/EPC network 500 includes a home Public Land Mobile Network (PLMN) 501 and one or more non-3GPP networks 550. Home PLMN 501 represents a packet core network where an end user of a UE 530 has subscribed to a service plan. Home PLMN 501 includes the following nodes of a PCC architecture: a Policy and Charging Rules Function (PCRF) 502, a Policy and Charging Enforcement Function (PCEF) 504 implemented in a packet data network gateway (PDN-GW) 506, an Online Charging System (OCS) 508, an application function (AF) 514, a Subscription Profile Repository (SPR)/Home Subscriber Server (HSS) 516, and a Network Traffic Data Repository (NTDR) 518. In addition, home PLMN 501 includes a 3GPP access network 532, a serving gateway (S-GW) 534, operator's IP services 536 (e.g., IP Multimedia Subsystem (IMS)), and an Authentication, Authorization and Accounting (AAA) server 538. Non-3GPP network 550 includes a trusted non-3GPP access network 551 and an un-trusted non-3GPP access network 552.

PDN-GW 506 is connected to one or more Packet Data Networks (PDN) 561. When a service data flow is established for a data service, the service data flows are established over the PDN 561. Assume for this embodiment that the end user of UE 530 has subscribed to a service plan with the operator of network 500, which may be referred to as “Plan 1”. Plan 1 defines the policy rules and the charging rules that will be used in a PCC decision if/when the end user attempts to access a service in home PLMN 501. PCRF 502 allows the end user to negotiate for a different service plan, as is further illustrated in FIG. 6.

FIG. 6 is a message diagram illustrating an example of negotiating for a new service plan in an exemplary embodiment. As stated above, the end user of UE 530 has subscribed to Plan 1. The end user of UE 530 may input data for a proposed service plan into UE 530, such as through a specialized interface designed for the service plan negotiation. The proposed service plan is indicated in FIG. 6 as “Plan 2”. Plan 2 offered by the end user differs from Plan 1 that is the predefined service plan for the end user. The differences between Plan 2 and Plan 1 depend on the preferences or desires of the end user. For example, the differences may include tariffs, bandwidths, QoS, etc. UE 530 then sends a request offering the proposed service plan (Plan 2) to PCRF 502 via AF 514.

In response to the request, PCRF 502 retrieves the predefined service plan for the end user to determine whether or not to accept the offer from the end user. Thus, PCRF 502 queries SPR/HSS 516 for the subscriber profile for the end user. SPR/HSS 516 responds with the subscriber profile that includes all or part of Plan 1, such as the policy rules defined for the end user. PCRF 502 also queries OCS 508 for charging rules (tariffs) for Plan 1. OCS 508 responds with the charging rules that are defined for Plan 1. PCRF 502 also identifies global policy and charging rules that may be applicable to the end user.

In addition to retrieving Plan 1 for the end user, PCRF 502 may retrieve additional data for determining whether or not to accept the offer from the end user. In this example, PCRF 502 queries NTDR 518 for current and history network traffic data. Network traffic data includes busy hour transactions rate (and semi-busy hour, off peak time), service usages per busy hour, bandwidth availability, registered subscribers, average QoS usages, etc. NTDR 518 responds with the network traffic data for LTE/EPC network 500.

After retrieving the information described above, PCRF 502 processes Plan 2 offered by the end user, and one or more of Plan 1 that is predefined for the end user, and the network traffic data to determine whether or not to accept the offer from the end user. In this example, PCRF 502 determines that Plan 2 does not meet the policy and charging rules, and rejects the end user's offer. In response to the rejection, PCRF 502 modifies Plan 2 to generate Plan 3 and Plan 4 as counter-offers to the end user. Plans 3 and 4 meet the policy and charging rules, and are a compromise between Plan 2 and Plan 1. For example, Plan 3 may offer a UL or DL bitrate cost at a point between the cost of Plan 1 predefined for the end user and the cost proposed by the end user in Plan 2. PCRF 502 then sends a response to UE 530 with Plans 3 and 4 through AF 514.

UE 530 displays Plans 3 and 4 to the end user, and gives the end user the option to select one of the plans. In this example, the end user accepts Plan 4 as a service plan. UE 530 then sends an answer to PCRF 502 accepting Plan 4. PCRF 502 then stores Plan 4 as a temporary service plan to use for the end user if he/she requests services from LTE/EPC network 500. As part of storing Plan 4, PCRF 502 may send Plan 4 to SPR/HSS 516 and OCS 508 for storage.

PCRF 502 may then use Plan 4 in PCC decisions for the end user. Again, Plan 4 is intended to be a temporary plan that is used under particular conditions. For example, Plan 4 may be used for PCC decisions during a particular time window, for particular services, when the end user is in particular locations, etc. After Plan 4 has expired, PCRF 502 may then revert back to the predefined service plan (Plan 1) for PCC decisions.

Any of the various elements shown in the figures or described herein may be implemented as hardware, software, firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non volatile storage, logic, or some other physical hardware component or module.

Also, an element may be implemented as non-transitory instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

Although specific embodiments were described herein, the scope of the invention is not limited to those specific embodiments. The scope of the invention is defined by the following claims and any equivalents thereof.

We claim:

1. A system comprising:
a policy management interface operable to communicate with an end user having a predefined service plan that is used for a Policy and Charging Control (PCC) decision in a packet core network, the policy management interface further operable to receive a request from the end user offering a proposed service plan that differs from the predefined service plan; and
a policy management controller operable to process the proposed service plan to determine whether to accept the offer from the end user;
wherein the policy management controller is further operable to implement the proposed service plan for the end user in a PCC decision for a service requested by the end user if the determination is to accept the proposed service plan.

2. The system of claim 1 wherein:
the policy management controller is further operable to implement the predefined service plan for the end user in a PCC decision for a service requested by the end user if the determination is to reject the proposed service plan.

3. The system of claim 1 wherein:
the policy management controller is further operable to generate an alternate service plan as a counter-offer to the end user, and to transmit a response to the end user offering the alternate service plan if the determination is to reject the proposed service plan.

4. The system of claim 3 wherein:
the policy management controller is further operable to receive an answer from the end user to the counter-offer; and
the policy management controller is further operable to implement the alternate service plan for the end user in a PCC decision for a service requested by the end user if the answer indicates acceptance of the counter-offer.

5. The system of claim 4 wherein:
the policy management controller is further operable to generate another alternate service plan as another counter-offer to the end user, and to transmit another response to the end user offering the other alternate service plan if the answer indicates rejection of the counter-offer.

6. The system of claim 1 wherein:
the policy management controller is further operable to process the proposed service plan, the predefined service plan, and network traffic data to determine whether to accept the offer from the end user.

7. The system of claim 6 wherein:
the policy management controller is further operable to retrieve the network traffic data from a network traffic data repository over a Diameter Sn interface.

8. The system of claim 1 wherein:
the policy management controller is further operable to retrieve a subscriber profile for the end user from a subscriber profile repository over a Diameter Sp interface, wherein the subscriber profile includes policy rules for the predefined service plan.

9. The system of claim 1 wherein:
the policy management controller is further operable to retrieve charging rules for the predefined service plan from an online charging system over a Diameter Sy interface.

10. A method of negotiating with an end user having a predefined service plan that is used for a Policy and Charging Control (PCC) decision in a packet core network, the method comprising:
receiving at a network node a request from the end user offering a proposed service plan that differs from the predefined service plan;
processing at the network device the proposed service plan to determine whether to accept the proposed service plan from the end user; and
if the determination is to accept the proposed service plan, then implementing the proposed service plan for the end user in a PCC decision for a service requested by the end user.

11. The method of claim 10 further comprising:
if the determination is to reject the proposed service plan, then implementing the predefined service plan for the end user in a PCC decision for a service requested by the end user.

12. The method of claim 10 further comprising:
if the determination is to reject the proposed service plan, then:
generating an alternate service plan as a counter-offer to the end user; and
transmitting a response to the end user with the alternate service plan.

13. The method of claim 12 further comprising:
receiving an answer from the end user to the counter-offer; and
if the end user accepted the counter-offer, then implementing the alternate service plan for the end user in a PCC decision for a service requested by the end user.

14. The method of claim 13 further comprising:
if the end user rejected the counter-offer, then:
generating another alternate service plan as another counter-offer to the end user; and
transmitting another response to the end user offering the other alternate service plan.

15. The method of claim 10 wherein processing the proposed service plan to determine whether to accept the proposed service plan from the end user further comprises:
processing the proposed service plan, the predefined service plan, and network traffic data to determine whether to accept the proposed service plan from the end user.

16. A Policy and Charging Control (PCC) architecture comprising:
a Policy and Charging Rules Function (PCRF) operable to communicate with an end user having a predefined service plan that is used for a Policy and Charging Control (PCC) decision in a packet core network;
the PCRF further operable to receive a request from the end user offering a proposed service plan that differs from the predefined service plan, and to process the proposed service plan to determine whether to accept the proposed service plan from the end user;
if the determination is to accept the proposed service plan, then the PCRF is further operable to implement the proposed service plan for the end user in a PCC decision for a service requested by the end user.

17. The PCC architecture of claim 16 wherein:
if the determination is to reject the proposed service plan, then the PCRF is further operable to generate an alternate service plan as a counter-offer to the end user, and to transmit a response to the end user offering the alternate service plan, and to receive an answer from the end user to the counter-offer; and
if the end user accepted the counter-offer, then the PCRF is further operable to implement the alternate service plan for the end user in a PCC decision for a service requested by the end user.

18. The PCC architecture of claim 16 further comprising:
a network traffic data repository;
wherein the PCRF is further operable to retrieve network traffic data from the network traffic data repository over a Diameter Sn interface to determine whether to accept the proposed service plan from the end user.

19. The PCC architecture of claim 16 further comprising:
a subscriber profile repository;
wherein the PCC architecture is further operable to retrieve a subscriber profile for the end user from the subscriber profile repository over a Diameter Sp interface, wherein the subscriber profile includes policy rules for the predefined service plan.

20. The PCC architecture of claim 16 further comprising:
an online charging system;
wherein the PCRF is further operable to retrieve charging rules for the predefined service plan from the online charging system over a Diameter Sy interface.
